(19) United States
(12) Patent Application Publication
(10) Pub. No.: US 2011/0102488 A1
(43) Pub. Date: May 5, 2011

(54) PRINTING DEVICE AND METHOD OF CONTROLLING PRINTING DEVICE

(75) Inventors: Hidenori Usuda, Matsumoto-shi (JP); Mitsuaki Yoshizawa, Minowa-shi (JP)

(73) Assignee: SEIKO EPSON CORPORATION, Shinjuku-ku (JP)

(21) Appl. No.: 12/939,946

(22) Filed: Nov. 4, 2010

(30) Foreign Application Priority Data
Nov. 5, 2009 (JP) 2009-254267
Apr. 7, 2010 (JP) 2010-088909

(51) Int. Cl. B41J 29/38

(52) U.S. Cl. 347/14

(57) ABSTRACT

Provided is a printing device including: nozzles which discharge a first aqueous ink for printing a main image; nozzles which discharge a second aqueous ink for printing a background image; and a control unit which controls printing of an image on a medium having an aqueous ink absorption property based on one selected from a first mode for printing the main image using the first aqueous ink and a second mode for superposing and printing the main image using the first aqueous ink and the background image using the second aqueous ink, wherein the amount of first aqueous ink dischargeable per unit area of the medium when the main image is printed on the medium in the second mode is less than that when the main image is printed on the medium in the first mode.

### INCORPORATED BY REFERENCE

The entire disclosure of Japanese Patent Application No.: 2009-254267, filed Nov. 5, 2009 and 2010-088909, filed Apr. 7, 2010 are expressly incorporated by reference herein.

### BACKGROUND

1. Technical Field

The present invention relates to a printing device and a method of controlling the printing device.

2. Related Art

As a printing device, there is an ink jet printer (hereinafter, referred to as a printer) having a head for discharging inks from nozzles to a medium, and a printer for performing printing using a white ink in addition to monochromic printing or color printing is known. In such a printer, for example, a color image is printed on a white background image so as to improve a color development property of the color image.

In addition, an image may be printed on a transparent film or the like as well as a paper medium. A printer capable of selecting a mode for printing a white background image on a medium and printing a color image on the background image or a mode for printing the color image on one surface of the medium and printing the white background image on the other surface of the medium at the same position where the color image is printed is suggested (for example, see JP-A-2009-56613).

However, in an ink jet printer, a limit value of the amount of ink dischargeable per unit area according to the property of an ink or a medium is set. As described above, in a mode for superposing and printing a white background image and a color image, as compared with a mode for printing only a color image, even when the same color image is printed, the amount of discharged ink per unit area of the medium is increased by the amount of white ink. Therefore, if the limit value of the amount of ink dischargeable per unit area is set regardless of the printing mode, in the mode for superposing and printing two images, the ink which is not absorbed into the medium flows out, the image is blurred, and image quality of the printed image deteriorates.

### SUMMARY

An advantage of some aspects of the invention is that deterioration in image quality of a printed image is suppressed.

According to an aspect of the invention, there is provided a printing device including: nozzles which discharge a first aqueous ink for printing a main image; nozzles which discharge a second aqueous ink for printing a background image; and a control unit which controls printing of an image on a medium having an aqueous ink absorption property based on one selected from a first mode for printing the main image using the first aqueous ink and a second mode for superposing and printing the main image using the first aqueous ink and the background image using the second aqueous ink, wherein the amount of first aqueous ink dischargeable per unit area of the medium when the main image is printed on the medium in the second mode is less than that when the main image is printed on the medium in the first mode.

The other features of the invention will be apparent from the present specification and the accompanying drawings.

### BRIEF DESCRIPTION OF THE DRAWINGS

The invention will be described with reference to the accompanying drawings, wherein like numbers reference like elements.

FIG. 1 is a block diagram showing the overall configuration of a printing system.

FIG. 2A is a schematic diagram of a printer and FIG. 2B is a diagram showing nozzle arrangement of a head.

FIG. 3 is a diagram explaining a printing mode selectable by the printer.

FIG. 4A is a diagram showing printing in a front-surface printing mode and FIG. 4B is a diagram showing printing in a rear-surface printing mode.

FIG. 5 is a flowchart illustrating a printing data generation process.

FIG. 6 is a flowchart illustrating a halftone process for a general color mode.

FIG. 7 is a diagram showing a dot generation rate table for a general color mode.

FIG. 8 is a diagram showing an ON/OFF determination state of a dot according to a dither method.

FIG. 9A is a diagram showing a dot generation rate table for four color inks in a front-surface/rear-surface printing mode, and FIG. 9B is a diagram showing a dot generation rate table for a white ink in a front-surface/rear-surface printing mode.

FIG. 10 is a diagram showing a difference in maximum ink discharge amount per unit area in each printing mode.

FIG. 11 is a diagram showing a maximum ink discharge amount per unit area of each printing mode in a modified example.

FIG. 12A is a diagram showing printing in a front-surface printing mode and FIG. 12B is a diagram showing printing in a rear-surface printing mode.

FIG. 13 is a diagram explaining another printing method.

### DESCRIPTION OF EXEMPLARY EMBODIMENTS

The following matter will be apparent from the present specification and the accompanying drawings.

That is, a printing device includes nozzles which discharge a first aqueous ink for printing a main image; nozzles which discharge a second aqueous ink for printing a background image; and a control unit which controls printing of an image on a medium having an aqueous ink absorption property based on one selected from a first mode for printing the main image using the first aqueous ink and a second mode for superposing and printing the main image using the first aqueous ink and the background image using the second aqueous ink, wherein the amount of first aqueous ink dischargeable per unit area of the medium when the main image is printed on the medium in the second mode is less than that when the main image is printed on the medium in the first mode.

According to the printing device, it is possible to prevent the aqueous ink from being discharged when this would exceed the absorption capability of the medium and to prevent bluffing of the printed image.

In the printing device, the total amount of first aqueous ink and second aqueous ink dischargeable per unit area of the medium in the second mode is greater than the amount of first aqueous ink dischargeable per unit area of the medium in the first mode.

According to the printing device, it is possible to improve the color development property of the main image while preventing blurring of the printed image.

In the printing device, a predetermined drying time is provided while the main image and the background image are respectively printed in the second mode.

According to the printing device, it is possible to set the total amount of first aqueous ink and second aqueous ink dischargeable per unit area in the second mode to be greater than the amount of first aqueous ink dischargeable per unit area in the first mode.

In the printing device, while a first nozzle array in which the nozzles for discharging the first aqueous ink are arranged in a predetermined direction, a second nozzle array in which the nozzles for discharging the second aqueous ink are arranged in the predetermined direction, and the medium are relatively moved in a movement direction intersecting the predetermined direction, an image forming operation for discharging the aqueous inks from the nozzles and an operation for moving the relative position between the first nozzle array and second nozzle array and the medium in one direction of the predetermined direction are repeated so as to print the image on the medium, and, in the second mode, of the main image and the background image, the nozzles for forming a first printed image in a predetermined area on the medium are located on the other direction side of the predetermined direction of the nozzles for forming a subsequently printed image in the predetermined area.

According to the printing device, it is possible to set the total amount of first aqueous ink and second aqueous ink dischargeable per unit area in the second mode to be greater than the amount of first aqueous ink dischargeable per unit area in the first mode.

In the printing device, the total amount of first aqueous ink and second aqueous ink dischargeable per unit area of the medium in the second mode is equal to the amount of first aqueous ink dischargeable per unit area of the medium in the first mode.

According to the printing device, it is possible to prevent blurring of the printed image.

In the printing device, in the second mode, the ink amount per one color of the second aqueous ink dischargeable per unit area of the medium is less than the ink amount per one color of the first aqueous ink dischargeable per unit area of the medium.

According to the printing device, it is possible to improve the color development property of the main image.

In the printing device, the background image is printed using the second aqueous ink and the first aqueous ink.

According to the printing device, it is possible to print the background image of a desired color.

A method of controlling a printing device including nozzles for discharging a first aqueous ink for printing a main image and nozzles for discharging a second aqueous ink for printing a background image includes executing an operation for selecting one from a first mode for printing the main image using the first aqueous ink and a second mode for superposing and printing the background image using the second aqueous ink; and executing an operation for setting the amount of first aqueous ink dischargeable per unit area of a medium having an aqueous ink absorption property to a predetermined amount and printing an image on the medium, if the first mode is selected, and setting the amount of first aqueous ink dischargeable per unit area of the medium to be less than the predetermined amount and printing the image on the medium, if the second mode is selected.

According to the method of controlling the printing device, it is possible to prevent the aqueous ink from being discharged when this would exceed the absorption capability of the medium and to prevent blurring of the printed image.

### Regarding Printing System

Hereinafter, a printing device is an ink jet printer (hereinafter, referred to as a printer), and an embodiment will be described using a printing system, in which the printer and a computer are connected, as an example.

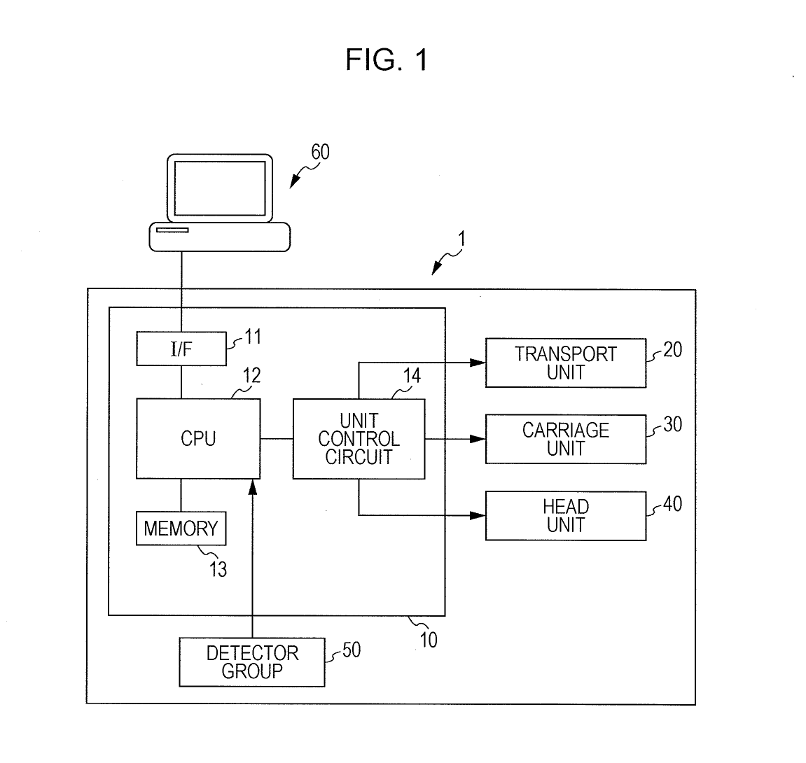

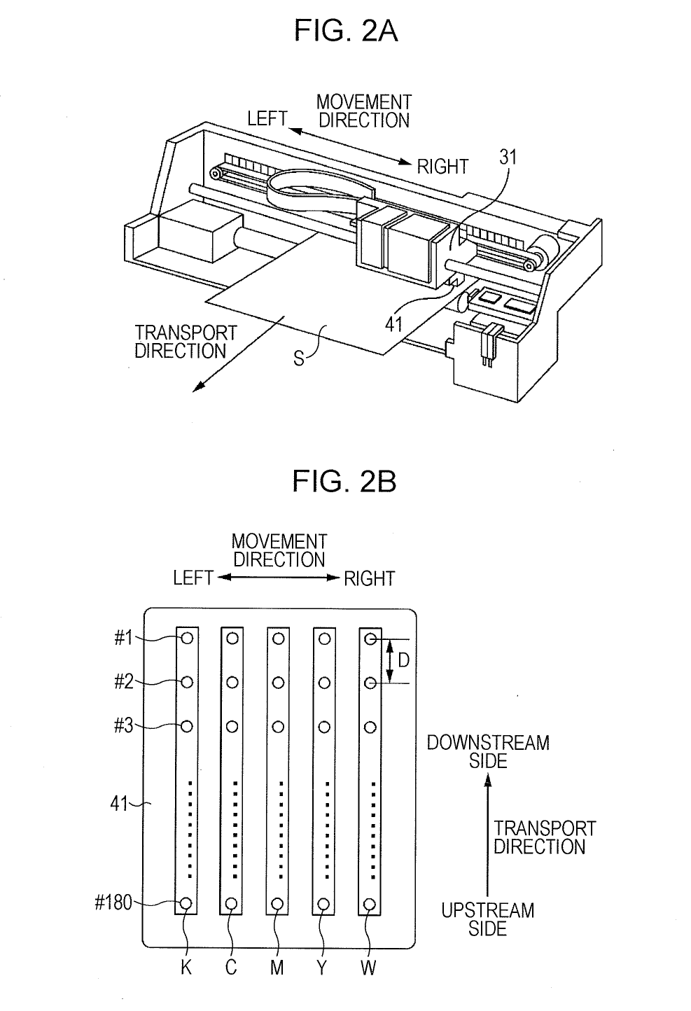

FIG. 1 is a block diagram showing the overall configuration of a printing system. FIG. 2A is a schematic diagram of a printer 1 and FIG. 2B is a diagram showing a nozzle arrangement of a head 41. Since the computer 60 is communicatively connected to the printer 1 so as to enable the printer 1 to print an image, printing data corresponding to the printed image is output to the printer 1. In the computer 60, a program (printer driver) for converting image data output from an application program into printing data is installed. This printer driver is recorded in a recording medium (computer-recordable recording medium) such as a flexible disk FD or a CD-ROM. Alternatively, the printer driver may be downloaded to the computer 60 through the Internet.

The printer 1 which receives a printing command and printing data from the computer 60 controls units by a controller 10 so as to print an image on a medium S. A detector group 50 monitors the internal status of the printer 1 and the controller 10 controls the units based on a detection result. An interface unit 11 in the controller 10 performs data transmission/reception between the computer 60, which is an external device, and the printer 1. A CPU 12 is an arithmetic processing unit for controlling the overall printer 1. A memory 13 secures a region for storing a program of the CPU 12, a work area, or the like. The CPU 12 controls the units by a unit control circuit 14.

A transport unit 20 feeds the medium S to a printable position and transports the medium S by a predetermined transport amount in a transport direction at the time of printing.

A carriage unit 30 moves the head 41 in a direction (hereinafter, referred to as a movement direction) intersecting the transport direction and has a carriage 31.

A head unit 40 discharges inks to the medium S and includes the head 41. The head 41 is moved by the carriage 31 in the movement direction. A plurality of nozzles which is an ink discharge unit is formed in a lower surface of the head 41 and a pressure chamber (not shown) in which the ink is filled is provided in each nozzle. FIG. 2B is a diagram showing the nozzle arrangement when viewed virtually from the surface of the head 41. As shown, five nozzle arrays in which 180 nozzles are arranged in the transport direction at a predetermined interval D are formed. A black nozzle array K for discharging a black ink, a cyan nozzle array C for discharging a cyan ink, a magenta nozzle array M for discharging a magenta ink, a yellow nozzle array Y for discharging a yellow ink, and a white nozzle array W for discharging a white ink are sequentially arranged from the left of the movement direction.

In such a printer 1, a dot forming process of intermittently discharging ink droplets from the head 41 moving along the movement direction so as to form dots on the medium and a transport process of transporting the medium relative to the head 41 in the transport direction are repeated. Therefore, it is possible to form dots at positions different from the positions of dots formed by a previous dot forming process and to print a two-dimensional image on the medium. In addition, an operation (one dot forming process) for moving the head 41 once in the movement direction while discharging ink droplets is called a “pass”.

### Regarding Printing Mode

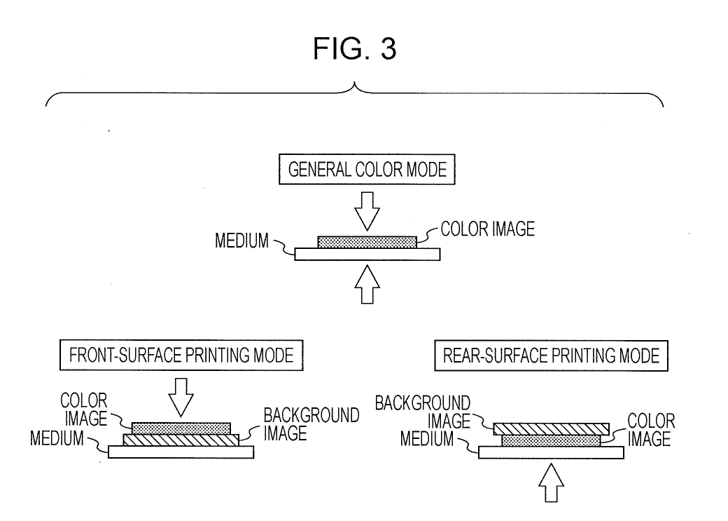

FIG. 3 is a diagram explaining a printing mode selectable by the printer 1. The printer 1 of the present embodiment can select three types of printing mode as shown in the case of a color image (including a monochromic image) using at least one of four color ink nozzle arrays (YMCK) and a transparent medium (for example, a transparent resin film or the like). The controller 10 (control unit) of the printer 1 controls printing of an image on a medium based on a printing mode selected by a user.

A first printing mode is a “general color mode (corresponding to a first mode)”, in which only a color image (hereinafter, referred to as a main image) is printed on a medium using four color ink nozzle arrays (YMCK). Therefore, in the general color mode, the white nozzle array W is not used. A second printing mode is a “front-surface printing mode (corresponding to a second mode)”, in which a background image is first printed in a predetermined area of a medium using the white nozzle array W and a main image is then printed on the background image using the four color ink nozzle array (YMCK). A third printing mode is a “rear-surface printing mode (corresponding to a third mode)”, in which a main image is first printed in a predetermined area of a medium using the four color ink nozzle arrays (YMCK) and a background image is then printed on the main image using the white nozzle array W. In the front-surface printing mode or the rear-surface printing mode, since the main image of the four color inks and the background image of the white color are superposed and printed, the color development of the main image is excellent. Even when the main mage is printed on a transparent medium (hereinafter, referred to as a transparent film), it is possible to prevent an opposite side of the main image from being transparent. Since an image is printed on a transparent film, as shown in FIG. 3, the main image printed in the general color mode can be viewed from both surfaces (printed surface side and medium side) of the medium. In contrast, the main image printed in the front-surface printing mode is viewed from the printed surface side and the main image printed in the rear-surface printing mode is viewed through the medium.

When the background image is printed using only the white ink, the white ink used to print the background image becomes the color of the background image. However, even in the same white ink, the hue of the white color varies slightly depending on the material of the ink or the like. Accordingly, a background image of a color different from a color desired by the user may be printed when using the white ink. In a certain printed material, a background image having a slight chromatic color may be desired to be used instead of a simple white color. If a white medium is used, even in the white medium, the hue of the white color varies slightly depending on the type of the medium. Therefore, when the background image is printed on the white medium, if the white color of the background image is different from the white color of the medium, the background image thus becomes conspicuous.

In the present embodiment, the background image of a desired white color (background image of an adjusted white color) is printed appropriately using a small amount of color inks (YMCK) together with the white ink. That is, when the background image is printed, a color ink of at least one of the color inks capable of being discharged from the printer 1 may be used. For example, all the color inks of four colors may be used or color inks of two colors may be used. In the case where the white ink has a slight hue by printing the background image using the white ink and the color inks, the background image may be approximated to an achromatic color by printing the background image together with an ink for canceling the hue.

In addition, printing data for printing the background image of the desired white color in the printer 1 may be stored in the printer 1 in advance or prepared by the printer driver. In the case where the user views the screen of the computer or the monitor of the printer 1 and selects the desired color of the background image, the printing data of the background image according to the selected color may be generated.

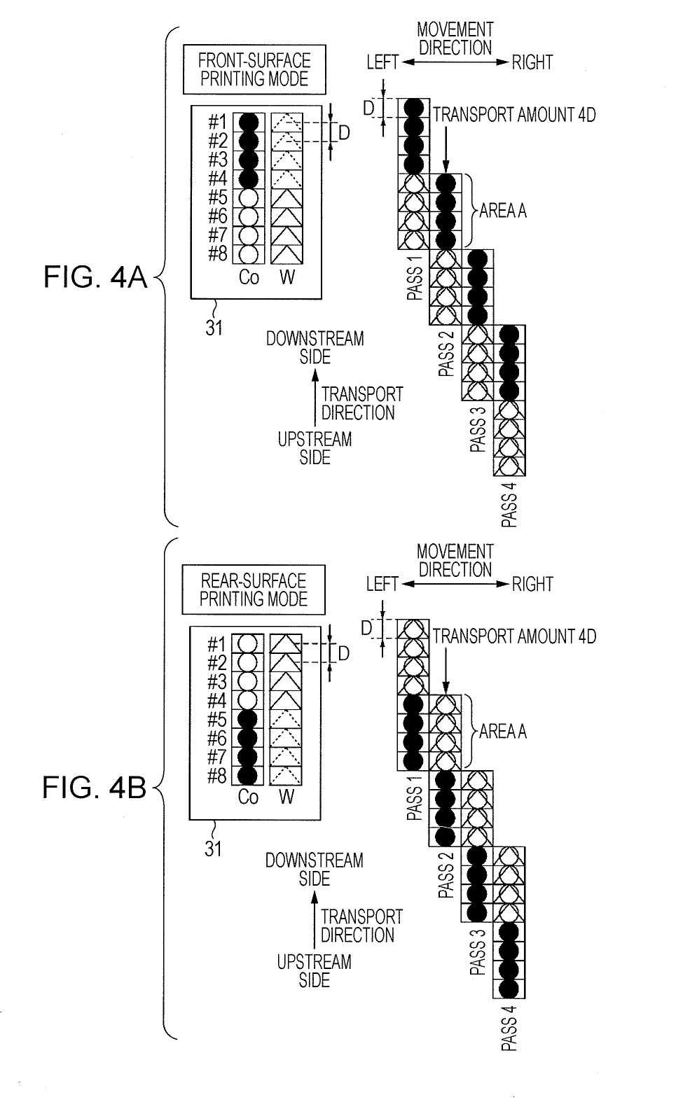

FIG. 4A is a diagram showing printing in a front-surface printing mode and FIG. 4B is a diagram showing printing in a rear-surface printing mode. In the printing in the general color mode (not shown), printing is performed using all the nozzles belonging to the four color nozzle arrays (YMCK) shown in FIG. 2B. In the front-surface printing mode and the rear-surface printing mode, since the main image and the background image are superposed and printed, in order to prevent blurring of the image, a drying time needs to be provided between a first printed image (lower-layer image) and a subsequently printed image (upper-layer image). The first printed image and the subsequent printed image are printed in different passes. Therefore, in the front-surface printing mode and the rear-surface printing mode, as shown in FIG. 4, printing is not performed using all the nozzles belonging to the nozzle arrays and each image is printed using nozzles corresponding to half of the nozzle arrays. In FIG. 4, for simplification of description, the number of nozzles per nozzle array is reduced to 8 and four color ink nozzle arrays (YMCK) are drawn together as a “color nozzle array Co”. In addition, in the printing method shown in FIG. 4, an image is configured by arranging the image formed in one pass in the transport direction. Accordingly, the transport amount of the medium for one transport operation becomes an image width (4D) formed using half (four nozzles) of the nozzle array in one pass.

First, in the front-surface printing mode (FIG. 4A), the nozzles #5 to #8 corresponding to half of the upstream side of the transport direction of the white nozzle array W and the nozzles #5 to #8 corresponding to half of the upstream side of the transport direction of the color nozzle array Co are set to be the nozzles (discharge nozzles Δ and ◯) used for printing the background image and the nozzles #1 to #4 corresponding to half of the downstream side of the transport direction of the color nozzle array Co are set to be the nozzles (discharge nozzles ) used for printing the main image. In the right diagram of FIG. 4A, the discharge nozzles A of the white nozzle array W and the discharge nozzles and ◯ of the color nozzle array Co are shown as one nozzle array and the positional relationship between the discharge nozzles in each pass is shown. By setting such discharge nozzles, as can be seen from the right diagram of FIG. 4A, while the medium is transported from the upstream side to the downstream side of the transport direction, for example, the background image can be first printed in the area A on the medium by the upstream nozzles #5 to #8 of the white nozzle array W and the color nozzle array Co in Pass 1 and the main image can be then printed on the background image of the area A by the downstream side nozzles #1 to #4 of the color nozzle array Co in Pass 2.

First, in the rear-surface printing mode (FIG. 4B), the nozzles #1 to #4 corresponding to half of the downstream side of the transport direction of the white nozzle array W and the nozzles #1 to #4 corresponding to half of the downstream side of the transport direction of the color nozzle array Co are set to be the nozzles (discharge nozzles Δ and ◯) used for printing the background image and the nozzles #5 to #8 corresponding to half of the upstream side of the transport direction of the color nozzle array Co are set to be the nozzles (discharge nozzles ) used for printing the main image. By setting such discharge nozzles, as can be seen from the right diagram of FIG. 4B, while the medium is transported from the upstream side to the downstream side of the transport direction, for example, the main image can be first printed in the area A on the medium by the upstream nozzles #5 to #8 of the color nozzle array Co in Pass 1 and the background image can be then printed on the main image of the area A by the downstream side nozzles #1 to #4 of the white nozzle array W and the color nozzle array Co in Pass 2.

When the main image and the background image are superposed and printed, the nozzles located on the upstream side of the nozzles for subsequently printing the image in the transport direction are set as the nozzles for first printing the image with respect to the predetermined area on the medium. Accordingly, it is possible to secure the drying time of the first printed image. As a result, even when two images are superposed and printed, it is possible to suppress blurring of the image.

The position of the transport direction of the nozzles Δ of the white nozzle array W for printing the background image and the position of the transport direction of the nozzles O of the color nozzle array Co for printing the background image are equalized. In order to print the background image, the white ink and the color ink are sprayed to the predetermined area of the medium in the same pass. As a result, the white ink and the color ink are mixed so as to deteriorate granularity of the background image.

The fraction of the color ink configuring the background image is less than the fraction of the white ink. In order to reduce granularity of the color ink in the background image, it is preferable that the dots of the color ink are uniformly dispersed. That is, the color ink density (dot density) per unit area of the background image is less than the white ink density (dot density) per the unit area of the background image. Therefore, the fraction of the color ink configuring the background image is less than the fraction of the white ink, but, in the present embodiment, the number of nozzles of the white nozzle array W used for printing the background image and the number of nozzles of the color nozzle array Co are equalized. That is, the background image is printed using the nozzles corresponding to half of the color nozzle array Co. The invention is not limited thereto and the background image may be printed using several nozzles of the nozzles corresponding to half of the color nozzle array Co which can be used for printing the background image.

Hereinafter, the ink discharge amount per unit area of the medium according to the printing mode will be described. In the present embodiment, the background image is printed using the white ink and at least one of the four color inks. The base color of the medium needs to be hidden by the white ink of the background image so as to protect the main image. Meanwhile, a slight chromatic color may be applied to the background image by the color ink for the background image. In order to enhance granularity of the color inks for the background image, the dot size of the color inks may be minimized. Accordingly, in order to form the background image, the color ink discharge amount per unit area of the medium is less than the white ink discharge amount per unit area of the medium. Therefore, the color ink discharge amount per unit area of the medium in order to form the background image has little influence on the maximum amount of ink dischargeable per unit area of the medium (duty limit value which will be described in detail later). Accordingly, hereinafter, for simplification of description, the ink for forming the background image is the white ink.

### Regarding Ink Discharge Amount Per Unit Area

### Regarding Ink Used in Present Embodiment

The ink used in the present embodiment may be an ink composition absorbed into a medium having an ink absorption property as an ink absorbed into the medium having an ink absorption property, is an “aqueous ink” including at least water as a solvent in order to secure the absorption property to the medium having the ink absorption property, and includes a pigment or a dye as a color material. For discharge stability from the ink jet head, an aqueous organic solvent may be included or a moisturizing agent, a penetration-enhancing agent, a pH adjuster, an insecticide, an ultraviolet absorbing agent or the like may be included if necessary. As the color inks (YMCK corresponding to a first aqueous ink) having such a composition, for example, the ink described in JP-A-2008-81693, JP-A-2005-105135 and JP-A-2003-292834 may be used. A white ink composition includes a hollow resin as a color material or a white pigment such as titanium oxide, and the components other than the color material are identical to that of the color inks. As the white ink (corresponding to a second aqueous ink), for example, the ink described in JP-A-2009-138078 and JP-A-2009-137124 may be used.

### Regarding Medium Used in Present Embodiment

The recording medium used in the present embodiment absorbs a solvent of the ink composition and the color material of the ink composition is adhered thereto. For example, a medium using a base material which absorbs an ink, such as paper or clothes, may be used or an ink absorption layer which absorbs an ink may be provided on a base material which absorbs ink or a base material which does not absorb an ink. In particular, if a transparent medium is used, the three printing modes shown in FIG. 3 may be used. As a transparent ink absorption medium, for example, a recording medium described in JP-A-2009-925, JP-A-9-99634 and JP-A-9-208870 may be used.

### Regarding Ink Discharge Amount Per Unit Area

As described above, in the printer 1 of the present embodiment, the aqueous ink is discharged from the nozzles such that the printed material shown in FIG. 3 is printed on the ink absorption medium (for example, a transparent film having an ink absorption layer) absorbing the aqueous ink. However, in such a printer 1, it is possible to improve a color development property of an image in respect to the ink discharge amount per unit area. However, since the ink absorption medium has a limit in ink absorption capability, if the ink is discharged when this would exceed the ink absorption capability (more particularly, if a large amount of ink is discharged for a short period of time), the ink which cannot be absorbed into the medium begins to flow out on the medium. As a result, ink droplets of different color inks reaching a vicinity of the medium are mixed into each other, bleeding (blurring) occurs and thus image quality deteriorates. That is, if the ink discharge amount per unit area of the medium is increased and the ink discharge amount exceeds the ink absorption capability of the medium, bleeding occurs.

In the printer 1, with respect to the used inks (YMCKW), a limit value of the amount of ink dischargeable per unit area of the medium is preset. In addition, the amount of ink dischargeable per unit area of the medium corresponds to a duty limit value (%), it may be set as the duty limit value. The duty limit value indicates a ratio of the number of dots (the amount of ink) actually dischargeable by the printer 1 according to the absorption capability of the medium to the number of dots (the amount of ink) dischargeable by the printer 1 per unit area of the medium. In order to prevent bleeding of the image, printing is performed using an amount of ink dischargeable per unit area less than with the limit value (duty limit value). Accordingly, in the present embodiment, when the printer driver in the computer 60 creates printing data, the amount of ink dischargeable per unit area (duty limit value) is considered. Since the ink absorption capability is changed according to the type of the medium, if the printer can print an image on various types of medium, the limit value of the amount of ink dischargeable per unit area of each medium may be set. For simplification of description, a medium on which the printer 1 prints an image is set to one type “transparent film having an ink absorption layer”.

In order to prevent the ink of an amount exceeding the ink absorption capability of the medium from being discharged, the amount of ink discharged at image data having a maximum concentration may be limited. That is, the ink discharge amount per unit area of the medium may be set to a maximum amount of ink dischargeable per unit area of the medium by the image data in which the gradation value of all the pixels belonging to the unit area is a maximum gradation value. For example, a black dot is formed alone. If the gradation value of black displayed by each of 100 pixels (10×10 pixels) belonging to the unit area is 255 and the gradation values of cyan, magenta and yellow are 0, the ink discharge amount per unit area is set to the maximum amount of ink dischargeable per unit area of the medium. In addition, the ink discharge amounts in the gradation values of the other color inks may be set based on the ink discharge amount in the maximum gradation value of black.

Regarding Printing Data Generation Process

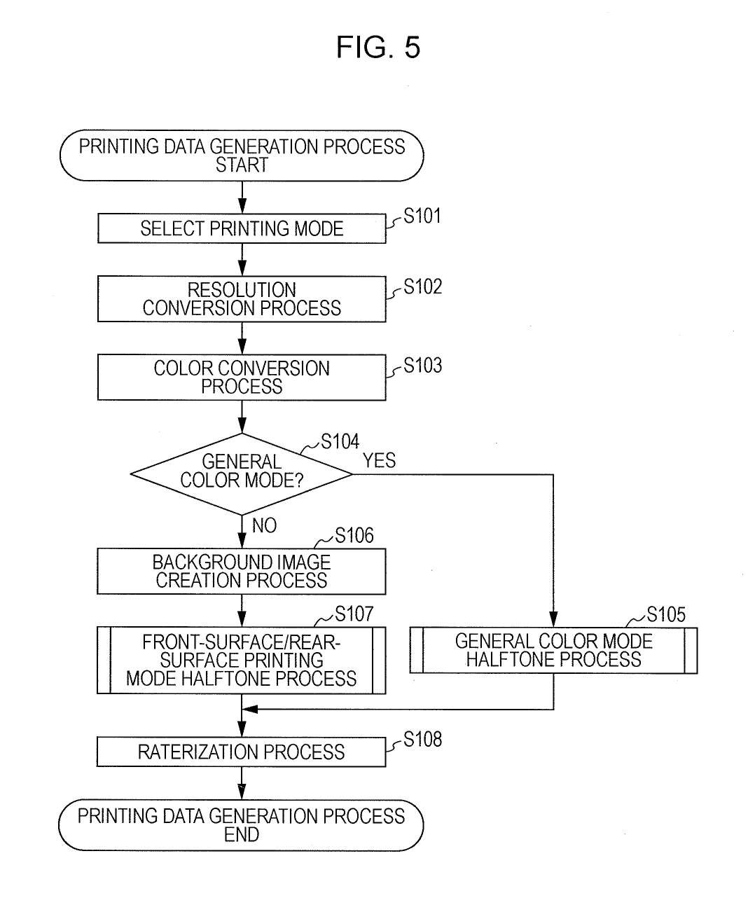

FIG. 5 is a flowchart illustrating a printing data generation process. Hereinafter, the printing data generation process will be described with reference to the flowchart. The printing data generation process is performed by the printer driver in the computer 60. The invention is not limited thereto and such a process may be performed by the controller 10 of the printer 1.

First, the printing mode is selected (S101). In the case where the printer deriver receives image data of a main image from an application program and prints the main image on a transparent medium (for example, a transparent film having an ink absorption layer), a window is displayed on a display device (display or the like) so as to enable the user to select one of three types of printing mode (general color mode, front-surface printing mode, and rear-surface printing mode) shown in FIG. 3. The selected printing mode is stored in the memory of the computer 60.

Next, a resolution conversion process (S102) is performed. The resolution conversion process indicates a process of converting the image data received from the application program into resolution when an image is printed on paper S.

Next, a color conversion process (S103) is performed. The color conversion process indicates a process of converting RGB image data into data having a multi-level gradation value shown by YMCK color spaces. This color conversion process is performed by referring to a table (color conversion lookup table) in which RGB luminance values correspond to YMCK gradation values.

Next, the printing mode is determined (S104). The determination of the printing mode is performed by referring to the printing mode stored in the memory of the computer 60. If the printing mode set by the user is the general color mode (S104−>Y), a halftone process for the general color mode is performed (S105 which will be described in detail later). In the general color mode, since only the main image is printed using four color inks YMCK, the halftone process for YMCK image data is performed. The halftone process indicates a process for converting YMCK(W) image data having a multi-level gradation value into small-level gradation data expressible by the printer 1. In the present embodiment, by the halftone process, the YMCK(W) data indicating 256-level gradation value per pixel is converted into 2-bit dot identification data indicating 4-level gradation value. That is, dot identification data (2-bit data) of “00” indicating that a dot is not formed, “01” indicating that a small dot is formed, “10” indicating that a middle dot is formed, and “11” indicating that a large dot is formed is set to each pixel.

Meanwhile, if the printing mode is not the general color mode, that is, if it is the front-surface printing mode or the rear-surface printing mode (S104−>N), a background image (background image data) creation process is performed (S106). In the front-surface printing mode or the rear-surface printing mode, the main image using the four color inks (YMCK) and the background image using the white ink are superposed and printed. In the background image creation process, the data of the background image, that is, the image data of the white ink (W) is created in accordance with the size of the printed main image. Here, the background image is a painted-out image using the white ink and the size of the background image is larger than that of the main image by a predetermined margin amount. Thereafter, a halftone process for the YMCK image data for the main image and the W image data for the background image is performed as the halftone process for the front-surface printing mode and the rear-surface printing mode (S107, which will be described in detail later).

Finally, a rasterization process (S108) is performed. The rasterization process indicates a process of changing a dot identification data which can be obtained by the halftone process into order of data to be transmitted to the printer 1. The dot identification data subjected to the rasterization process is sent to the printer 1 as printing data, together with command data or the like. The printer 1 performs printing according to the received printing data.

### Regarding Halftone Process

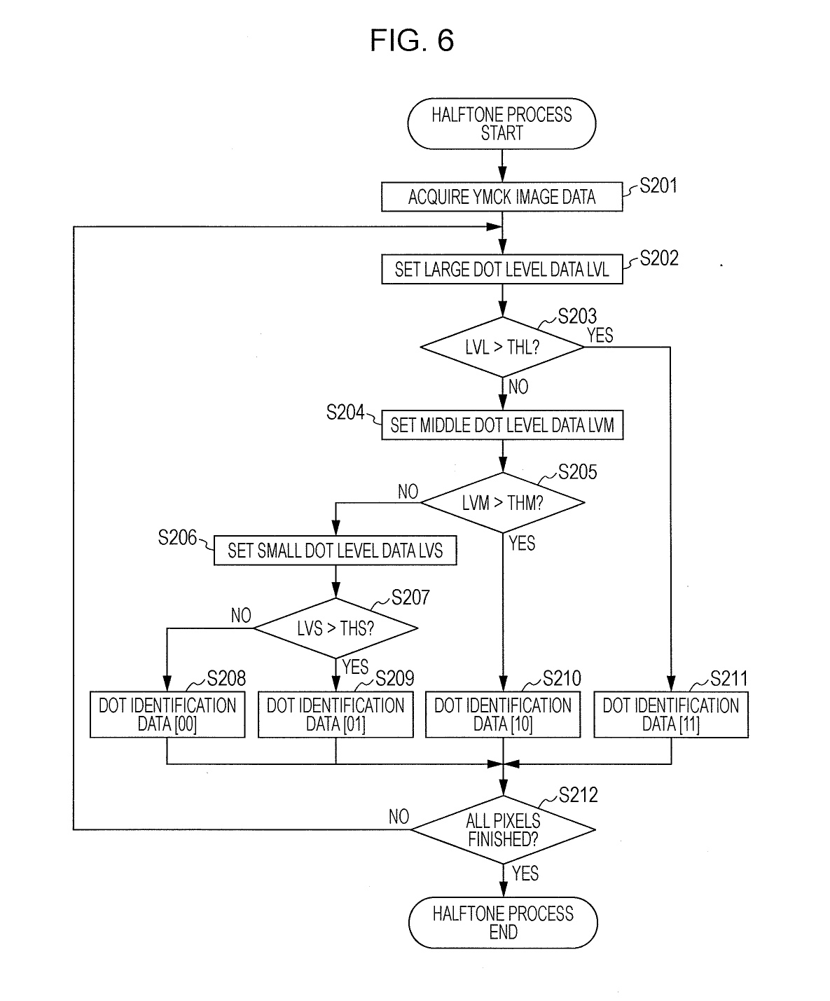

FIG. 6 is a flowchart illustrating the halftone process for the general color mode. First, the halftone process for the general color mode (in the case where only the main image is printed), that is, the halftone process for the YMCK image data will be described. In addition, the halftone process of the present embodiment is performed using a dither method. However, the invention is not limited thereto, and, for example, an error diffusion method or the like may be used.

First, the printer driver acquires the YMCK image data after the color conversion process (S103 of FIG. 5) (S201 of FIG. 6). This YMCK image data includes Y image data for yellow, M image data for magenta, C image data for cyan and K image data for black. Each of the Y, M, C and K image data includes pixel data (256-level gradation value) indicating the gradation value of the color of each ink. Since the following description is applicable to any one of the Y, M, C and K image data, the K image data will be representatively described. With respect to all K pixel data of the K image data, the process from step S202 to step S212 of FIG. 6 is executed while sequentially changing the K pixel image to be processed. As a result, each K pixel data belonging to the K image data is converted into 2-bit data “dot identification data” which indicates any one of “00” indicating that a dot is not formed, “01” indicating that a small dot is formed, “10” indicating that a middle dot is formed, and “11” indicating that a large dot is formed”.

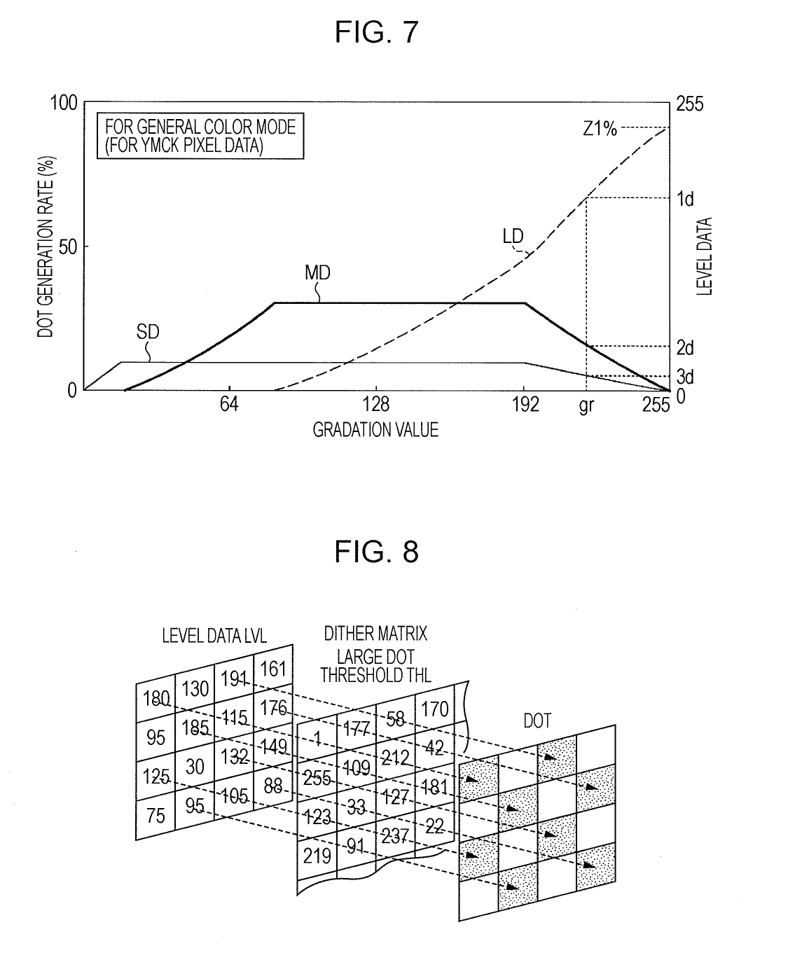

FIG. 7 is a diagram showing a dot generation rate table for a general color mode. A horizontal axis of the drawing shows a gradation (0 to 255) of pixel data and a left vertical axis shows a dot generation rate (%), and a right vertical axis shows level data (0 to 255). The higher the gradation value is (255), the darker the image becomes. The “dot generation rate” indicates a ratio of pixels, in which dots are formed, to the pixels belonging to the unit area when a uniform area (unit area) is reproduced according to a constant gradation value. The dot generation rate is set in consideration of the duty limit value. For example, if the unit area is composed of 16×16 pixels, the gradation value of all pixel data in the unit area is constant, and n dots are formed in the unit area, the dot generation rate of the constant gradation value becomes {n/(16×16)}×100(%). A profile SD shown by a thin solid line of the drawing denotes a small-dot generation rate, a profile MD shown by a thick solid line denotes a middle-dot generation rate, and a profile LD shown by a dotted line denotes a large-dot generation rate. The level data indicates data, for which the dot generation rate is converted into a 256-level value of 0 to 255. Although each four-color (YMCK) image data is subjected to the halftone process using the dot generation rate table (FIG. 7), the invention is not limited thereto and a dot generation rate table may be provided to image data of each color (YMCK).

Hereinafter, the flow of the halftone process will be described. First, as shown in step S202 of FIG. 6, level data LVL according to the gradation value shown by the K pixel data to be processed is read from the profile LD (dotted line of FIG. 7) for the large dot. For example, as shown in FIG. 7, if the gradation value of the K pixel data to be processed is gr, 1d is obtained as the level data LVL using the profile LD. Actually, this profile LD is stored in the memory in the computer 60 in the form of a one-dimensional table, and the printer driver obtains level data by referring to this table.

Next, in step S203, it is determined whether or not the set level data LVL is greater than a threshold THL. Here, dot ON/OFF determination of the dot is performed according to the dither method. The threshold THL uses a matrix in which each pixel block of a dither matrix is expressed by a value of 0 to 255. In addition, the threshold is set per dot size, a threshold for a large dot is set to THL, a threshold for a middle dot is set to THM, and a threshold for a small dot is set to THS.

FIG. 8 is a diagram showing an ON/OFF determination state of a dot according to a dither method. For simplification of description, in the drawing, one part of the K pixel data of the pixel data (level data LVL) belonging to the K image data is shown. As shown, the level data LVL of each K pixel data is compared with the threshold THL for the large dot of the pixel block on the dither matrix corresponding to the pixel data (S203). If the level data LVL is greater than the threshold THL, the large dot is set to ON and, if the level data LVL is less than the threshold THL, the large dot is set to OFF. In the drawing, the shaded pixel data is the K pixel data in which the large dot is set to ON. That is, in step S203, if the level data LVL is greater than the threshold THL (S203−>Y), the process progresses to step S211 and, otherwise, progresses to step S204. When the process progresses to step S211, the printer driver records the K pixel data to be processed in correspondence with the dot identification data “11” indicating the large dot creation and the process progresses to step S212. A determination as to whether the processing of all K pixel data is finished is made, if finished, the halftone process of the K image data is finished, and, if not finished, the object to be processed transitions to the unprocessed K pixel data and the process returns to step S202.

In contrast, if the process progresses to step S204, the printer driver sets the level data LVM of the middle dot. The level data LVM of the middle dot is read from the profile MD (thick line of FIG. 7) for the middle dot according to the gradation value shown by the K pixel data to be processed. For example, as in the example of FIG. 7, if the gradation value of the K pixel data is gr, 2d is obtained as the level data LVM. In step S205, the level data LVM of the middle dot and the threshold THM for the middle dot are compared in magnitude, and the ON/OFF determination of the middle dot is performed. The method of determining ON/OFF is equal to that of the large dot.

In step S205, if the level data LVM for the middle dot is greater than the threshold THM for the middle dot (S205−>Y), it is determined that the middle dot is set to ON, and the process progresses to step S210, otherwise (S205−>N), the process progresses to step 206. When the process progresses to step S210, the printer driver records the K pixel data to be processed in correspondence with the dot identification data “10” indicating the middle dot creation, and a determination is made as to whether there are K pixel data to be subsequently processed or the process is finished.

Meanwhile, when the process progresses to step S206, similar to the level data of the large dot or the middle dot, the level data LVS of the small dot is set from the profile SD (narrow line of FIG. 7) for the small dot. In step S207, the printer driver determines whether or not the level data LVS of the small dot is greater than the threshold THS for the small dot. If the level data LVS is greater than the threshold THS(S207−>Y), the process progresses to step S209, otherwise (S207−>N), the process progresses to step S208. When the process progresses to step S209, the K pixel data to be processed is recorded in correspondence with the dot identification data “01” indicating the small dot creation, and, when the process progresses to step S208, the K pixel data to be processed is recorded in correspondence with the dot identification data “00” indicating that the dot is not formed. After the halftone process for all K pixel data belonging to the K image data is finished, the same halftone process is executed with respect even to the image data of different colors (YMC). By performing the halftone process, the ink can be discharged by the amount according to the gradation value shown by the image data.

The maximum amount of ink dischargeable per unit area of the medium (duty limit value) is added to the dot generation rate table (FIG. 7) used when the halftone process is executed. The maximum amount of each ink (YMCK) dischargeable per unit area is set based on the maximum amount of ink dischargeable per unit area set according to the property of the medium or the ink. Here, in the general color mode, a maximum of four color (YMCK) dots are superposed and formed with respect to one pixel. For example, the unit area is composed of 16×16 pixels and a maximum amount (X/4) of a certain ink (one color of YMCK) dischargeable per unit area is set to ¼ of a maximum sum amount (X) of four color inks dischargeable per unit area. In the dot generation rate table of FIG. 7, only the large dot is formed when the gradation value is a maximum value of 255. Therefore, the number (Y) obtained by converting the maximum amount (X/4) of a certain color ink dischargeable per unit area into the number of large dots corresponds to the number of large dots of a certain color formed in the unit area when the gradation value shown by all pixel data in the unit area is the maximum value of 255. The ratio {Y/(16×16)}×100% of the number Y of large dots formed in the unit area to the number of pixels (16×16 pixels) belonging to the unit area becomes the dot generation rate (for example, Z1% of the drawing) of the large dot for a certain color when the gradation value is the maximum value of 255. The maximum amount (X/4) of a certain color ink dischargeable per unit area is divided stepwise and the dot generation rate for each gradation value (0 to 255) is set. By creating the dot generation rate in consideration of the maximum amount of ink dischargeable per unit area (duty limit value), it is possible to prevent the ink from being discharged when this would exceed the absorption capability of the medium and to suppress bleeding of the image even in the case where the gradation value is the maximum value of 255.

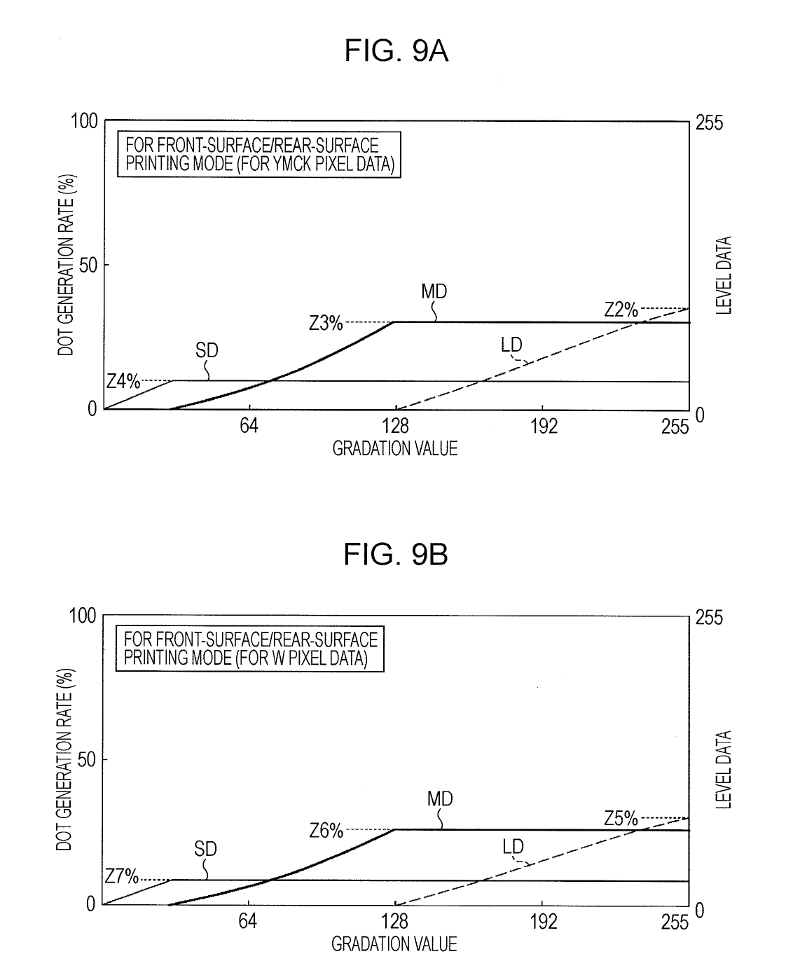

FIG. 9A is a diagram showing a dot generation rate table for four color inks (YMCK) in a front-surface/rear-surface printing mode, and FIG. 9B is a diagram showing a dot generation rate table for a white ink (W) in a front-surface/rear-surface printing mode. In the present embodiment, as shown in the flow of the printing data generation process of FIG. 5, the halftone process (S105) for the general color mode and the halftone process for the front-surface/rear-surface printing mode are differentiated. Even in the halftone process of the front-surface/rear-surface printing mode, the same process as the general color mode is performed according to the flow shown in FIG. 6. However, halftone process for the general color mode and the halftone process for the front-surface/rear-surface printing mode are differentiated in the dot generation rate table for setting the level data LVL, LVM and LVS of each dot.

The dot generation rate table for the four color pixel data (YMCK) of the general color mode shown in FIG. 7 and the dot generation rate table for the four color pixel data (YMCK) of the front-surface/rear-surface printing mode shown in FIG. 9A are compared. Then, in the maximum gradation value of 255, the large dot generation rate (Z2%) of the front-surface/rear-surface printing mode is set to be significantly less than the large dot generation rate (Z1%) of the general color mode. This is because only the main image using the four color inks (YMCK) is printed on the medium in the general color mode, whereas the main image using the four color inks (YMCK) and the background image using the white ink (W) are superposed and printed on the medium in the front-surface/rear-surface printing mode.

That is, even with the same maximum amount of ink dischargeable per unit area (duty limit value), a maximum of four color (YMCK) dots is superposed and formed with respect to one pixel in the general color mode, whereas a maximum of five color (YMCK+W) dots is superposed and formed with respect to one pixel in the front-surface/rear-surface printing mode. Accordingly, as compared with the general color mode, in the front-surface/rear-surface printing mode, it is necessary to reduce the total amount of four color (YMCK) inks dischargeable per unit area by the amount of white ink. If the halftone process for the YMCK image data of the front-surface/rear-surface printing mode is performed using the dot generation rate table (FIG. 7) of the halftone process for the YMCK image data of the general color mode, the ink of the amount exceeding the absorption capability of the medium is discharged and bleeding occurs in the image. Therefore, in the present embodiment, the dot generation rate table (FIG. 7) of YMCK for the general color mode and the dot generation rate table (FIG. 9A) of YMCK for the front-surface/rear-surface printing mode are differentiated. In addition, when all pixels belonging to the unit area have a maximum gradation value of 255, the dot generation rate of each mode is set such that the amount of ink discharged per unit area in the front-surface/rear-surface printing mode is less than the amount of ink discharged per unit area in the general color mode.

In detail, as shown in FIG. 9A, the dot generation rate (Z2%) of the large dot of the front-surface/rear-surface printing mode is set to be less than the dot generation rate (Z1%) of the large dot of the general color mode. Meanwhile, in the maximum gradation value (255), the dot generation rates of the middle dot and the small dot are zero in the dot generation rate table (FIG. 7) of the general color mode, whereas the dot generation rate (Z3%) of the middle dot and the dot generation rate (Z4%) of the small dot are greater than zero in the dot generation rate table (FIG. 9A) of the front-surface/rear-surface printing mode. Therefore, in the case where all the pixels belongs to the unit area (for example, 16×16 pixels) are set to the maximum gradation value of 255, the large dots are formed in the pixels of Z1% of the unit area in the general color mode, whereas the large dots are formed in the pixels of Z2% of the unit area, the middle dots are formed in the pixels of Z3%, and the small dots are formed in the pixels of Z4% in the front-surface/rear-surface printing mode. In addition, the dot generation rate of each mode is set such that the sum of the amount of ink forming the large dots in the pixels of Z2% of the unit area, the amount of ink forming the middle dots in the pixels of Z3% of the unit area and the amount of ink forming the small dots in the pixels of Z1% of the unit area is less than the amount of ink forming the large dots in the pixel of Z1% of the unit area. In addition, not only in the maximum gradation value but in each gradation value (0 to 255), the dot generation rate of each gradation value is set such that the total amount of four color inks (YMCK) discharged per unit area in the front-surface/rear-surface printing mode is less than the total amount of four color inks discharged per unit area in the general color mode.

Accordingly, even in the case where the main image and the background image are superposed and printed in the front-surface/rear-surface printing mode, it is possible to prevent the ink of the amount exceeding the absorption capability of the medium from being discharged. As a result, it is possible to prevent bleeding from occurring in the image and to suppress deterioration in image quality of the printed image. In other words, if the halftone process of the YMCK image data of the general color mode is performed using the dot generation rate table (FIG. 9A) for YMCK of the front-surface/rear-surface printing mode, the amount of ink discharged to the medium is restricted beyond necessity. As a result, the color development property of the main image printed in the general color mode deteriorates. Therefore, by setting the dot generation rate table according to the modes, it is possible to print a higher-quality image (an image in which bleeding does not occur or an image having a good color development property).

In a high gradation value (for example, 255), only the large dots are formed in the general color mode, whereas three types of dots are formed in the front-surface/rear-surface printing mode. As described above, generally, it is possible to improve the color development property of the image in respect to the ink discharge amount per unit area. However, since the maximum ink discharge amount per unit area (duty limit value) of the front-surface/rear-surface printing mode is less than that of the general color mode, the color development property of the main image using the four color inks (YMCK) is reduced. Instead, in the front-surface/rear-surface printing mode, since the middle dots and the small dots are generated even in the high gradation, it is possible to enhance the granularity of the image.

In the present embodiment, when the halftone process for the front-surface/rear-surface printing mode is performed, the dot generation rate table (FIG. 9A) of the four color inks (YMCK) and the dot generation rate table (FIG. 9B) of the white ink (W) are differentiated. The dot generation rate of each dot in the dot generation rate table of the white ink is set to be overall less than that in the dot generation rate table of the four color inks (YMCK). In detail, in the maximum gradation value of “255”, the dot generation rate Z2% of the large dot of the four color inks is higher than the dot generation rate Z5% of the large dot of the white ink, the dot generation rate Z3% of the middle dot of the four color ink is higher than the dot generation rate Z6% of the large dot of the white ink, and the dot generation rate Z4% of the small dot of the four color inks is higher than the dot generation rate Z7% of the small dot of the white ink.

Since the background image using the white ink is superposed and formed on the main image using the four color inks, the protecting property for the main image can be secured by printing the background image, and the need to improve the color development property of the image is low in the background image, as compared with in the main image using the four color inks. Accordingly, even when the amount of each color ink discharged per unit area in order to form the background image is less than the amount of each color ink discharged per unit area in order to form the main image using the four color inks, a problem does not occur. By setting the dot generation rate (FIG. 9A) used in the halftone process for the YMCK image data for printing the main image to be greater than the dot generation rate (FIG. 9B) used in the halftone process for the W image data for printing the background image, it is possible to increase the ink discharge amount of the main image and to improve the color development property of the main image, while suppressing bleeding of the image. The invention is not limited thereto and the dot generation rate table of the four color inks (YMCK) and the dot generation rate table of the white ink (W) may be used in common.

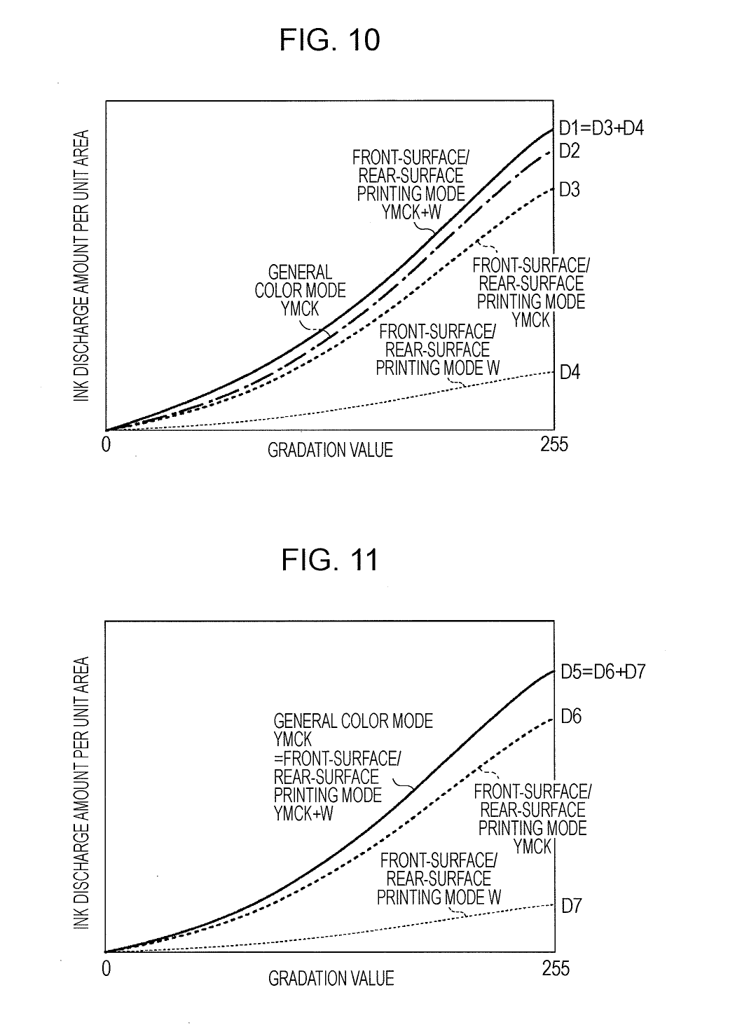

FIG. 10 is a diagram showing a difference in maximum ink discharge amount per unit area in each printing mode. A horizontal axis denotes a gradation value 0 to 255 shown by the pixel data and a vertical axis an ink discharge amount per unit area. The ink discharge amount is increased toward an upper side of the vertical axis. In the drawing, the total amount of five color inks (YMCK+W) discharged per unit area in the front-surface/rear-surface printing mode is denoted by a solid line, the total amount of four color inks (YMCK) discharged per unit area in the general color mode is denoted by a dashed dotted line, the total amount of four color inks (YMCK) discharged per unit area in the front-surface/rear-surface printing mode is denoted by a thick dotted line, and the amount of white ink discharged per unit area in the front-surface/rear-surface printing mode is denoted by a thin dotted line. The sum of the ink discharge amount (thick dotted line) of the four color inks (YMCK) and the ink discharge amount (thin dotted line) of the white ink (W) in the front-surface/rear-surface printing mode corresponds to the ink discharge amount (solid line) of the five color inks (YMCK+W) in the front-surface/rear-surface printing mode. For example, when the gradation value of all the pixels belonging to the unit area is the maximum value of 255, the amount of white ink discharged in the unit area in order to print the background is D4, the amount of four color inks (YMCK) discharged in the unit area in order to print the main image is D3, and the total amount of ink discharged in the unit area becomes D1 (=D3+D4).

As can be seen from FIG. 10, in the present embodiment, the ink discharge amount (thick dotted line D3) of the four colors (YMCK) per unit area in the front-surface/rear-surface printing mode is set to be less than the ink discharge amount (dashed dotted line D2) of the four colors (YMCK) per unit area in the general color mode. Therefore, even when the main image and the background are superposed and printed in the front-surface/rear-surface printing mode, it is possible to prevent the ink from being discharged when this would exceed the absorption capability of the medium and to suppress bleeding of the image.

In the present embodiment, the dot generation rate (FIGS. 7 and 9) of each printing mode is set such that the ink discharge amount (solid line D1) of the five colors (YMCK+W) per unit area in the front-surface/rear-surface printing mode is set to be greater than the ink discharge amount (dashed dotted line D2) of the four colors (YMCK) per unit area in the general color mode. That is, in the present embodiment, the maximum ink discharge amount per unit area (duty limit value) when the background image and the main image are printed in the front-surface/rear-surface printing mode is greater than the maximum ink discharge amount per unit area (duty limit value) when only the main image is printed in the general color mode. This is because the pass for printing the main image and the pass for printing the background image are differentiated as shown in FIG. 4 such that the main image and the background image are not blurred when the front-surface/rear-surface printing mode is performed.

The maximum ink amount dischargeable per unit area (duty limit value) is related to an ink discharge period. Even in the case where the same amount of ink is discharged with respect to the unit area, the ink which cannot be absorbed into the medium more easily flows out on the medium when the ink is discharged once for a short period of time, as compared with when the ink is discharged several times. That is, it is possible to increase the maximum ink amount (duty limit value) dischargeable per unit area when the ink is divisionally discharged plural times with respect to the unit area, as compared with when the ink is discharged once for a short period of time.

The four color inks (YMCK) are discharged with respect to the unit area in one pass in the general color mode, whereas the four color inks (YMCK) and the white ink (W) are discharged with respect to the unit area in two passes in the front-surface/rear-surface printing mode, the total amount of five color inks dischargeable per unit area in the front-surface/rear-surface printing mode may be greater than the total amount of four color inks dischargeable per unit area in the general color mode. As a result, while the ink discharge amount for printing the main image in order to suppress bleeding in the front-surface/rear-surface printing mode is reduced as compared with the general color mode, it is possible to increase the amount of ink for printing the main image as much as possible by providing a drying time while the main image and the background are printed. As a result, it is possible to improve the color development property of the main image. The invention is not limited to the printing method shown in FIG. 4, and, if a printing method of providing a predetermined drying time while the main image and the background image are printed is used, it is possible to increase the total amount of ink dischargeable per unit area in the front-surface/rear-surface printing mode, as compared with the general color mode.

The drying time provided while the main image and the background image are printed may be provided between passes or in the same pass. The printer may be a line printer which individually includes a line head (a plurality of heads arranged in a paper width direction) for printing the main image and a line head for printing the background image. In this printer, a time when the medium is transported between two line heads may be the drying time while the main image and the background image are printed. The medium may be heated at the drying time when the main image and the background image are printed.

### Modified Example

FIG. 11 is a diagram showing a maximum ink discharge amount per unit area of each printing mode in a modified example. In the above-described embodiment, as shown in FIG. 10, the dot generation rate of each printing mode is set such that the total amount (solid line) of five color inks per unit area in the front-surface/rear-surface printing mode is greater than the total amount (dashed dotted line) of the four color inks per unit area in the general color mode, but the invention is not limited thereto. As in this modified example, the dot generation rate of each printing mode may be set such that the total amount (solid line) of five color inks per unit area in the front-surface/rear-surface printing mode is equal to the total amount (dashed dotted line) of the four color inks per unit area in the general color mode.

In this case, the sum of the amount (thin dotted line d7) of white ink discharged to the unit area in the front-surface/rear-surface printing mode and the amount (thick dotted line d6) of four color inks (YMCK) discharged to the unit area in the front-surface/rear-surface printing mode becomes the amount (solid line D5=D6+D7) of four color (YMCK) inks discharged to the unit area in the general color mode.

Although the background image in which the hue of the white color is adjusted using the white ink and the color inks is described as an example in the above-described embodiment, the invention is not limited thereto. The background image printed using only the white ink may be printed. However, in this case, only the background image using the white ink can not be printed. Therefore, a background image of a desired color may not be printed or a difference between the color of the background image and the background color of the medium may become conspicuous. Accordingly, a high-quality background image cannot be printed. Hereinafter, an example of printing the background image using only the white ink will be described.

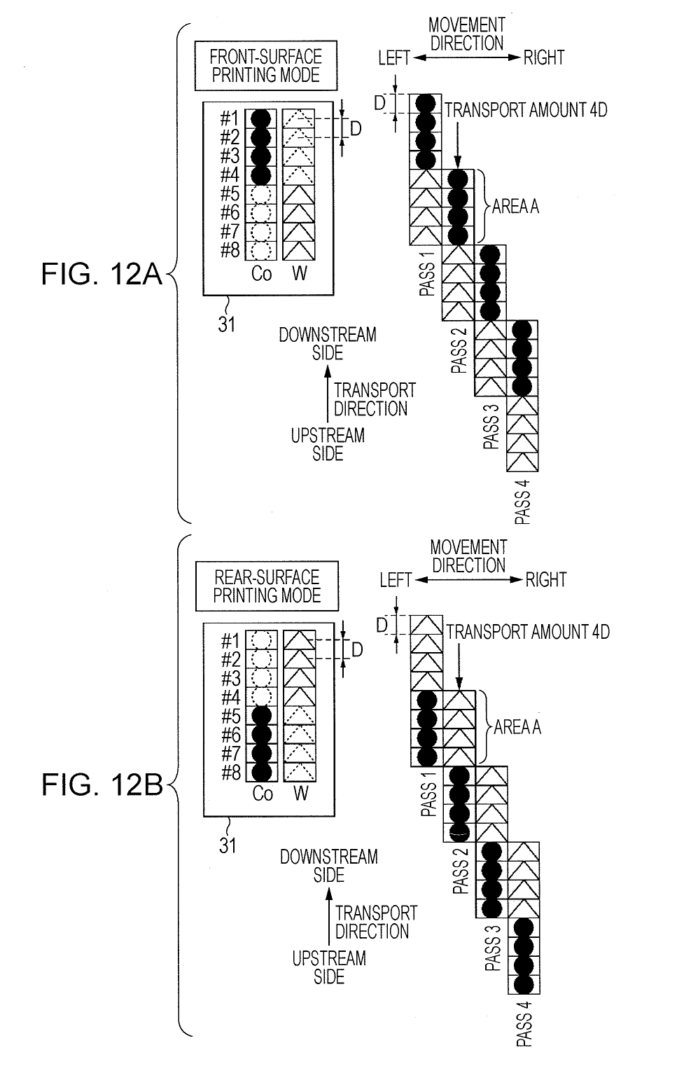

FIG. 12A is a diagram showing printing in a front-surface printing mode and FIG. 12B is a diagram showing printing in a rear-surface printing mode. The printing in the general color mode (not shown) is performed using all the nozzles belonging to the four color nozzle arrays (YMCK) shown in FIG. 2B. Meanwhile, since the main image and the background image are superposed and printed in the front-surface printing mode and the rear-surface printing mode, it is necessary to provide a drying time between a first printed image (lower-layer image) and a subsequently printed image (upper-layer image) in order to prevent blurring of the image. Therefore, the first printed image and the subsequently printed image are printed in different passes. Accordingly, in the front-surface printing mode and the rear-surface printing mode, as shown in FIG. 12, printing is not performed using all the nozzles belonging to the nozzle arrays, but each image is printed using the nozzles corresponding to half of the nozzle arrays. In addition, in FIG. 12, for simplification of description, the number of nozzles belonging to one nozzle array is reduced to 8 and the nozzle arrays (YMCK) of the four color inks are collectively shown as a “color nozzle array Co”. In the printing method shown in FIG. 12, an image formed by one pass is arranged in the transport direction so as to configure an image. Accordingly, the medium transport amount of one transport operation becomes an image width (4D) formed in half (four nozzles) of the nozzle array in one pass.

First, in the front-surface printing mode (FIG. 12A), the nozzles #5 to #8 corresponding to half of the upstream side of the transport direction of the white nozzle array W are set to be the nozzles (discharge nozzles Δ) used for printing the background image and the nozzles #1 to #4 corresponding to half of the downstream side of the transport direction of the color nozzle array Co are set to be the nozzles (discharge nozzles ) used for printing the main image. In the right diagram of FIG. 12A, the discharge nozzles Δ of the white nozzle array W and the discharge nozzles of the color nozzle array Co are shown by one nozzle array and a positional relationship between the discharge nozzles in each pass is shown. By such setting of the discharge nozzles, as can be seen from the right diagram of FIG. 12A, while the medium is transported from the upstream side to the downstream side of the transport direction, for example, with respect to the area A on the medium, the background image can be first printed by the upstream nozzles #5 to #8 of the white nozzle array W in Pass 1 and the main image can be then printed on the background image of the area A by the downstream nozzles #1 to #4 of the color nozzle array Co in Pass 2.

Meanwhile, in the rear-surface printing mode (FIG. 12B), the nozzles #1 to #4 corresponding to half of the downstream side of the transport direction of the white nozzle array W are set to be the nozzles (discharge nozzles Δ) used for printing the background image and the nozzles #5 to #8 corresponding to half of the upstream side of the transport direction of the color nozzle array Co are set to be the nozzles (discharge nozzles ) used for printing the main image. By such setting of the discharge nozzles, as can be seen from the right side of FIG. 12B, while the medium is transported from the upstream side to the downstream side of the transport direction, for example, with respect to the area A on the medium, the main image can be first printed by the upstream nozzles #5 to #8 of the color nozzle array Co in Pass 1 and the background image can be then printed on the main image of the area A by the downstream nozzles #1 to #4 of the white nozzle array W in Pass 2.

In the case where the main image of the four color inks (YMCK) and the background image of the white ink are superposed and printed, the nozzles for first printing the image are set to be located on the upstream side of the nozzles for subsequently printing the image in the transport direction with respect to the predetermined area on the medium. Since the first formed image and the subsequently formed image can be printed in different passes, it is possible to secure the drying time of the first formed image. As a result, even when two images are superposed and printed, it is possible to suppress blurring of the image.

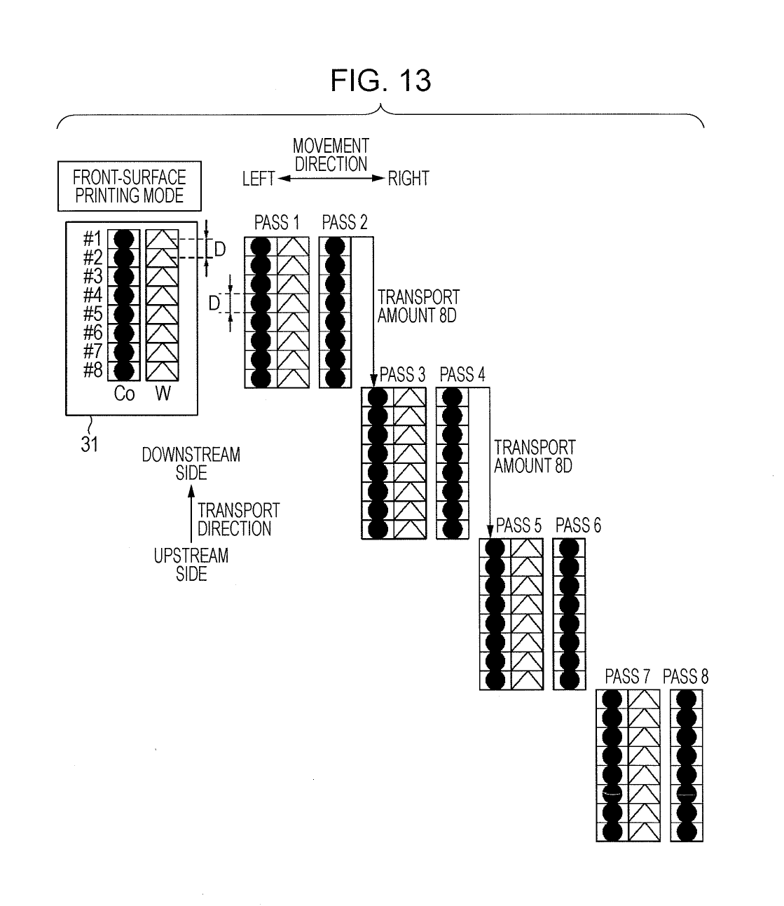

FIG. 13 is a diagram explaining another printing method. In the above-described embodiment, as shown in FIG. 4, since the nozzles for first printing the image are located on the upstream side of the nozzles for subsequently printing the image in the predetermined direction with respect to the predetermined area of the medium, each image is printed using the nozzles corresponding to half of the nozzle array. However, the invention is not limited thereto. For example, as shown in FIG. 13, each image may be printed using all the nozzles of the white nozzle array W and the color nozzle array Co. However, if the background image and the color image are printed in the same pass, the image is blurred. Each image may be printed in each pass. For example, FIG. 13 shows a printing example of the front-surface printing mode. First, the background image is printed using all the nozzles of the white nozzle array W and the color nozzle array Co in Pass 1 and the color image is printed using all the nozzles of the color nozzle array Co in Pass 2 without transporting the medium to the downstream side of the transport direction. Thereafter, the medium is transported by the length of the nozzle array, the background image is printed using all the nozzles of the white nozzle array W and the color nozzle array Co in Pass 3, and the color image is printed using all the nozzles of the color nozzle array Co in Pass 4 without transporting the medium. Accordingly, it is possible to print the color image on the background image without blurring. In the rear-surface printing mode, the color image is printed using all the nozzles of the color nozzle array Co in Pass 1 and the background image is printed using all the nozzles of the white nozzle array W and the color nozzle array Co in Pass 2 without transporting the medium.

Although the color image is printed using only the four color inks (YMCK) in the above-described embodiment, the invention is not limited thereto. For example, the color image may be printed using the white ink together with the four color inks. In this case, in the front-surface printing mode shown in FIG. 4A, the color image is printed using the nozzles #1 to #4 corresponding to half of the downstream side of the transport direction of the color nozzle array Co and the white nozzle array W. Meanwhile, in the rear-surface printing mode shown in FIG. 4B, the color image is printed using the nozzles #5 to #8 corresponding to half of the upstream side of the transport direction of the color nozzle array Co and the white nozzle array W. The position of the transport direction of the nozzles of the color nozzle array Co for printing the color image and the position of the transport direction of the nozzles of the white nozzle array W for printing the white image are aligned. Then, in order to print the color image, the color inks and the white ink are sprayed to the predetermined area of the medium in the same pass. By printing the color image using the white ink as well as the color inks, it is possible to print an image capable of exhibiting a color with high luminosity and high chromaticness.

### Other Embodiments

Although the printing system having the ink jet printer as a main component is described in the embodiments, the disclosure of the creation of the printing data or the like is included. The above embodiments are described to facilitate the understanding of the invention and are not interpreted to restrict the invention. Modifications and changes of the invention may be made without departing from the scope of the invention and the invention includes equivalents thereof.

Regarding Ink and Medium

In the invention, an ink and a medium (ink absorption recording medium) having an ink absorption property to absorb the ink are used. As the ink absorption recording medium, a recording medium formed of a base material having an ink absorption property or a recording medium including an ink reception layer formed on a base material may be used. As the base material having the ink absorption property, there is paper, clothes or the like. As the base material including the ink reception layer formed thereon, a base material having an ink absorption property or a base material which does not absorb an ink may be used. As a material of the base material, for example, a resin film such as a polyester film, a polyolefin film or polyvinyl chloride, paper such as regular paper, coated paper or tracing paper, resin coated paper, synthetic paper, or the like may be used.

As the ink reception layer, a known ink reception layer generally provided on a recording medium for an ink jet recording method may be used. As the known ink reception layer, for example, an ink reception layer formed of a resin is known. As an example of the resin used in the ink reception layer, for example, various polymers having an ink absorption property such as polyvinyl pyrrolidone or vinyl pyrrolidone acetate copolymer disclosed in JP-A-57-38185, JP-A-62-184879 or the like, a poly(vinyl alcohol)-based resin composition disclosed in JP-A-60-168651, JP-A-60-171143, or JP-A-61-134290, a copolymer of vinyl alcohol and olefine or stylene and maleic anhydride disclosed in JP-A-60-234879, a cross linking substance of polyethylene oxide and isocyanate disclosed in JP-A-61-74879, a mixture of carboxymethylcellulose and polyethylene oxide disclosed in JP-A-61-181679, a polymer in which methacrylamide is grafted to polyvinyl alcohol disclosed in JP-A-61-132377, an acrylic polymer having a carboxyl group disclosed in JP-A-62-220383, a polyvinyl acetal-based polymer disclosed in JP-A-4-214382 or the like, a cross-linking acrylic polymer disclosed in JP-A-4-282282 or JP-A-4-285650, or the like may be used.

As the known ink reception layer, an ink reception layer in which a polymer matrix formed of a cross-linking polymer and an absorption polymer are concurrently used is disclosed in JP-A-4-282282, JP-A-4-285650 or the like. Further, an ink reception layer using hydrated alumina (cationic hydrated alumina) is known, and, for example, JP-A-60-232990, JP-A-60-245588, JP-B-3-24906, JP-A-6-199035, JP-A-7-82694 or the like discloses a recording medium in which fine pseudo-boehmite-form alumina hydrate is applied on a surface of a base material together with an aqueous binder. For example, JP-A-10-203006 discloses an ink reception layer using synthetic silica using a gas phase method, in which a primary particle diameter is mainly 3 nm to 30 nm. Further, JP-A-2001-328344 discloses an ink reception layer including an inorganic pigment and a polymer adhesive. In the invention, a film base material including each of the above-described ink reception layer formed thereon may be preferably used.

In the invention, as the composition of the white ink for the background image, a certain white ink composition which is generally used in an ink jet recording method may be used. As such a white pigment, for example, an inorganic white pigment, an organic white pigment, or white hollow polymer microparticle may be used. As the white ink composition, an aqueous ink composition containing hollow polymer microparticle as a coloring agent component is preferably used.

As the inorganic white pigment, alkaline earth metal sulphate such as barium sulfate, alkaline earth metal carbonate such as calcium carbonate, silicas such as fine powdered silicic acid or synthetic silicate, calcium silicate, alumina, hydrated alumina, titanium oxide, zinc oxide, talc, clay or the like may be used. In particular, titanium oxide is known as a white pigment which is preferable in protecting, coloring, and dispersion particle diameter.

As the organic white pigment, organic compound salt disclosed in JP-A-11-129613 or alkylenebismelamine derivative disclosed in JP-A-11-140365 or JP-A-2001-234093 may be used. As a detailed product of the white pigment, there is ShigenoxOWP, ShigenoxOWPL, ShigenoxFWP, ShigenoxFWG, ShigenoxUL, ShigenoxU (all of which are made by Hakkooru Chemical Co., Ltd. and are product names) or the like.

The hollow polymer microparticle contained as the coloring agent component may be a particle having an outer diameter of about 0.1 to 1 μm and an inner diameter of about 0.05 to 0.8 μm, should not be soluble in a solvent of a white ink composition, and should not chemically react with the other component, for example, a binder resin component.

In each of the hollow polymer microparticles, a wall is formed of a synthetic polymer to which a liquid is permeable both inwards and outwards, and the liquid can go in or out a space of a central portion of the hollow polymer microparticle through the wall. The space of the central portion of the hollow polymer microparticle is filled by a solvent in an ink composition state, the specific gravity of the hollow polymer microparticle and the specific gravity of the ink composition are substantially equal, and the hollow polymer microparticles are stably dispersed in the ink composition. When this ink composition is printed on a printed surface and is dried, the space of the central portion of the hollow polymer microparticle is replaced with air. Therefore, incident light is irregularly reflected in the resin and the space and a white color is substantially exhibited.

The hollow polymer microparticle may be of a type, in which the liquid is contained in the microparticle before printing, but the liquid contained in the microparticle is diffused through the wall of the microparticle after printing so as to fill a fine hole of the microparticle with air, as described above, or a fully sealed type in which air is contained from the beginning.

Since it is preferable that the hollow polymer microparticle used in the white ink composition is not precipitated in the ink composition, the hollow polymer microparticle preferably has the same specific gravity as the ink composition solution. Therefore, as necessary, the specific gravity of the ink composition solution is preferably adjusted using a specific gravity-regulating agent such as glycerol.

As a commercially available product of the hollow polymer microparticle satisfying the above-described property, for example, Ropaque OP-62 commercially available from Rohm and Haas Company may be used. This is an aqueous dispersion containing 38-wt % hollow polymer microparticles formed of an acrylic/styrene copolymer. The inner diameter of this microparticle is about 0.3 μm, the outer diameter thereof is about 0.5 μm, and water is filled therein.

The hollow polymer microparticle can be obtained by a known manufacturing method, for example, a method disclosed in U.S. Pat. No. 4,089,800. This hollow polymer microparticle is substantially formed of an organic polymer and exhibits a thermoplastic property. As the thermoplastic resin used to manufacture the hollow polymer microparticle, preferably, a copolymer of a cellulose derivative, an acrylic resin, polyolefin, polyamide, polycarbonate, polystyrene, styrene or another vinyl monomer, a vinyl polymer such as a homopolymer or copolymer of vinyl acetate, vinyl alcohol, vinyl chloride or vinyl butyral, a homopolymer and copolymer of diene, or the like may be used. In particular, as the preferable thermoplastic polymer, a copolymer such as 2-hexyl acrylate copolymer or methyl methacrylate, a copolymer of styrene and another vinyl monomer such as acrylic nitrile may be used.

The content of the hollow polymer microparticles in the white ink composition used in the invention may be, for example, 0.1 to 20 wt %. If the content of the hollow polymer microparticles is equal to or greater than 0.1 wt %, a sufficient degree of whiteness can be obtained. If the content of the hollow polymer microparticles is equal to or less than 20 wt %, a sufficient amount of ink binder resin component necessary for securing the viscosity required in the ink composition for ink jet printing can be contained and, as a result, a sufficient printing adhesion property can be secured.

In the invention, the above white pigment may be used alone or in combination. In the dispersion of the pigment, a ball mill, a sand mill, an Attritor, a roll mill, an agitator, a Henschel mixer, a colloid mill, an ultrasonic homogenizer, a pearl mill, a wet jet mill, a paint shaker or the like may be used. When the pigment is dispersed, a dispersing agent may be added.

The white ink composition used in the present invention may contain various components generally contained in the ink composition for ink jet printing, for example, a resin component, a dispersing agent component, a solvent component (in particular, water) or the like, in addition to a white coloring agent component. In addition, in the present specification, the solvent and the solvent medium have the same meaning. As the white ink composition containing the hollow polymer microparticles as the white coloring agent, for example, a composition disclosed in Japanese Patent No. 3562754 or Japanese Patent No. 3639479 may be used.

The non-white ink composition for the color image used in the invention is, for example, a color ink composition, a black ink composition or a gray ink composition. As the color ink composition, for example, a cyan ink composition, a magenta ink composition, a yellow ink composition, a light cyan ink composition, a light magenta ink composition, a red ink composition, a green ink composition, or a blue ink composition or the like may be used. The non-white ink composition may be a combination of one or two or more of the above-described various ink compositions.

As the non-white ink composition, a certain non-white ink composition which is generally used in the ink jet recording method may be used, and an aqueous ink composition containing a dye or a pigment as the coloring agent component may be preferably used. In particular, an ink composition exhibiting a good property (for example, a color development property or fixability) with respect to a transparent film base material or an ink reception layer may be preferably used.

### Regarding Amount of Ink Dischargeable Per Unit Area

Although the difference in the amount of ink dischargeable per unit area (duty limit value) between the general color mode and the front-surface/rear-surface printing mode is applied to the dot generation rate table (FIGS. 7 and 9) used in the halftone process in the above-described embodiments, the invention is not limited thereto. The difference in amount of ink dischargeable per unit area according to the difference between the printing modes may be applied to a color conversion lookup table used in the color conversion process or applied to a dither matrix of a dither method (halftone process). The difference in amount of ink dischargeable per unit area of the medium may be applied in any manner.

### Regarding Background Image

Although the background image is printed using the white ink in the above-described embodiments, the invention is not limited thereto and the background image may be printed using a color ink (for example, a metallic ink) other than the white ink. The invention is not limited to the printing of the background image using only the white ink, the other color inks may be mixed to the white ink and the background image in which the hue of the white color is adjusted may be printed or the main image may be printed by adding the white ink to the four color inks (YMCK). If the other color inks are added to the main image or the background image, the amount of ink discharged per unit area is changed. Thus, the dot generation rate table (duty limit value) may be adjusted according to the printing methods.

### Regarding Other Printers

Although the printer 1 for repeating the operation for forming the image while moving the heads 41 in the movement direction and the operation for transporting the medium in the transport direction is described in the above embodiments, the invention is not limited thereto. For example, a printer for forming an image through a continuous medium under a plurality of fixed heads or a printer for alternately repeating the operation for forming the image with respect to a continuous sheet transported to a printing area while moving a head along a transport direction of the continuous sheet and the operation for moving the head in a paper width direction intersecting the transport direction so as to form the image and, thereafter, transporting the medium portion, on which the image is not printed, to a printing area may be used.

### Regarding Printing Device

As a method of discharging inks from nozzles, a piezoelectric method of applying a voltage to driving elements (piezoelectric elements) and expanding and contracting ink chambers so as to discharge inks may be used or a thermal method of generating air bubbles in nozzles using a heating element and discharging inks by the air bubbles may be used.

What is claimed is:

1. A printing device comprising:
nozzles which discharge a first aqueous ink for printing a main image;
nozzles which discharge a second aqueous ink for printing a background image; and
a control unit which controls printing of an image on a medium having an aqueous ink absorption property based on one selected from a first mode for printing the main image using the first aqueous ink and a second mode for superposing and printing the main image using the first aqueous ink and the background image using the second aqueous ink,
wherein the amount of first aqueous ink dischargeable per unit area of the medium when the main image is printed on the medium in the second mode is less than that when the main image is printed on the medium in the first mode.

2. The printing device according to claim 1, wherein the total amount of first aqueous ink and second aqueous ink dischargeable per unit area of the medium in the second mode is greater than the amount of first aqueous ink dischargeable per unit area of the medium in the first mode.

3. The printing device according to claim 2, wherein a predetermined drying time is provided while the main image and, the background image are respectively printed in the second mode.

4. The printing device according to claim 3, wherein:
while a first nozzle array in which the nozzles for discharging the first aqueous ink are arranged in a predetermined direction, a second nozzle array in which the nozzles for discharging the second aqueous ink are arranged in the predetermined direction, and the medium are relatively moved in a movement direction intersecting the predetermined direction, an image forming operation for discharging the aqueous inks from the nozzles and an operation for moving the relative position between the first nozzle array and second nozzle array and the medium in one direction of the predetermined direction are repeated so as to print the image on the medium, and
in the second mode, of the main image and the background image, the nozzles for forming a first printed image in a predetermined area on the medium are located on the other direction side of the predetermined direction of the nozzles for forming a subsequently printed image in the predetermined area.

5. The printing device according to claim 1, wherein the total amount of first aqueous ink and second aqueous ink dischargeable per unit area of the medium in the second mode is equal to the amount of first aqueous ink dischargeable per unit area of the medium in the first mode.

6. The printing device according to claim 1, wherein, in the second mode, the ink amount per one color of the second aqueous ink dischargeable per unit area of the medium is less than the ink amount per one color of the first aqueous ink dischargeable per unit area of the medium.

7. The printing device according to claim 1, wherein the background image is printed using the second aqueous ink and the first aqueous ink.

8. A method of controlling a printing device including nozzles for discharging a first aqueous ink for printing a main image and nozzles for discharging a second aqueous ink for printing a background image, the method comprising:
executing an operation for selecting one from a first mode for printing the main image using the first aqueous ink and a second mode for superposing and printing the background image using the second aqueous ink; and
executing an operation for setting the amount of first aqueous ink dischargeable per unit area of a medium having an aqueous ink absorption property to a predetermined amount and printing an image on the medium, if the first mode is selected, and setting the amount of first aqueous ink dischargeable per unit area of the medium to be less than the predetermined amount and printing the image on the medium, if the second mode is selected.
